(19) United States
(12) Patent Application Publication
(10) Pub. No.: US 2025/0039053 A1
(43) Pub. Date: Jan. 30, 2025

(54) READING RETRIEVING CONFIGURATION DATA API FOR OAM FUNCTIONS

(71) Applicant: RAKUTEN MOBILE, INC., Tokyo (JP)

(72) Inventors: Pankaj SHETE, Tokyo (JP); Awn MUHAMMAD, Tokyo (JP)

(73) Assignee: RAKUTEN MOBILE, INC., Tokyo (JP)

(21) Appl. No.: 18/696,590

(22) PCT Filed: Dec. 28, 2023
(86) PCT No.: PCT/US2023/086133

§ 371 Date: Mar. 28, 2024

Related U.S. Application Data
(60) Provisional application No. 63/440,162, filed on Jan. 20, 2023.

(51) Int. Cl. H04L 41/0869; H04L 41/085

(52) U.S. Cl. CPC H04L 41/0869; H04L 41/085

(57) ABSTRACT

Provided are a method, system, for retrieving configuration data API for a RAN OAM related function including receiving, by an API producer, a HTTP GET configuration data request, the HTTP GET configuration data request originates from an API consumer, wherein the GET configuration data request comprises a resource URI and query criteria; determining, by the API producer, whether the HTTP GET configuration data request is valid or not; upon determining that the HTTP GET configuration data request is valid, obtaining, by the API producer, a configuration data based on the resource URI and the query criteria; and sending, by the API producer, a HTTP GET response, the HTTP GET response comprising a message based on the determination of whether the HTTP GET configuration data request is valid or not, wherein the message includes the configuration data if the HTTP GET configuration data request was determined as being valid.

### BACKGROUND

### 1. Field

Systems and methods consistent with example embodiments of the present disclosure relate to providing a method for retrieving configuration data API's for radio access network (RAN) operation and maintenance (OAM) functions.

### 2. Description of Related Art

A radio access network (RAN) is an important component in a telecommunications system, as it connects end-user devices (or user equipment (UE)) to other parts of the network. The RAN includes a combination of various network elements (NEs) that connect the end-user devices to a core network. Traditionally, hardware and/or software of a particular RAN is vendor specific.

Recently, the evolution of telco technologies enables many telco services to be realized virtually, in the form of software. For instance, RANs such as Open RAN (O-RAN) architectures, disaggregate one network component into multiple functional elements. By way of example, a baseband unit (BBU) or base station (i.e., eNB or gNB) is disaggregated into a number of functional elements including a distributed unit (DU) and a centralized unit (CU), wherein the CU can be further disaggregated into Centralized Unit-Control Plane (CU-CP) and Centralized Unit-User Plane (CU-UP). The disaggregation of network elements enables the telco services and the associated functions to be defined and provided in software-based form or virtual network services, such as Virtualized Network Functions (VNFs), Cloud-native Network Functions (CNFs) or Software Defined Networking (SDN), among others.

RAN functions in the O-RAN architecture are controlled and optimized by a RIC. The RIC is a software-defined component that implements modular applications to facilitate the multivendor operability required in the O-RAN system, as well as to automate and optimize RAN operations. The RIC is divided into two types: a non-real-time RIC (Non-RT RIC) and a near-real-time RIC (Near-RT RIC).

The Non-RT RIC is the control point of a non-real-time control loop and operates on a timescale greater than 1 second within the Service Management and Orchestration (SMO) framework. Its functionalities are implemented through modular applications called rApps, and include: providing policy based guidance and enrichment across the A1 interface, which is the interface that enables communication between the Non-RT RIC and the Near-RT RIC; performing data analytics; Artificial Intelligence/Machine Learning (AI/ML) training and inference for RAN optimization; and/or recommending configuration management actions over the O1 interface, which is the interface that connects the SMO to RAN managed elements (e.g., Near-RT RIC, O-RAN centralized Unit (O-CU), O-RAN Distributed Unit (O-DU), etc.).

The SMO framework manages and orchestrates RAN elements. Specifically, the SMO includes a Federated O-Cloud Orchestration and Management (FOCOM), a Network Function Orchestrator (NFO) that manages Virtual Machines (VM) based VNF and container (i.e., instance) based VNF, and the Operation and Management (OAM) as a part of the SMO that manages and orchestrates what is referred to as the O-Ran Cloud (O-Cloud).

Further, the SMO may include an operational support system (OSS) and an element management system (EMS), each of which is configurable to perform one or more of: fault management operation, configuration management operation, account management operation, performance management operation, and security management operation (FCAPS operations), on one or more services hosted or deployed in the servers. In some embodiments, the service management system may include a plurality of EMSs, each of the plurality of EMSs may be configured to manage a single service or a group of services associated with a particular vendor/service provider, and the OSS interfaces between the monitoring system, orchestrator, and the plurality of EMSs. Accordingly, the SMO may provide a single control point for managing a plurality of services (associated with multiple vendors/network service providers) via only one monitoring system and one orchestrator system (i.e., one monitoring system and one orchestrator system can be utilized to manage services associated with multiple vendors/service providers).

### SUMMARY

In the related art, for an OAM related service, a service producer, as an API consumer, may need to obtain a configuration data (e.g., the value of a field of a configuration field) from an API producer. However, the related art does not describe any procedure with respect to the above. Accordingly, there is a need to be able to retrieve configuration data.

Example embodiments of the present disclosure provide a method and system for retrieving configuration data API for a RAN OAM-related function including: receiving, by an API producer, a HTTP GET configuration data request, wherein the HTTP GET configuration data request originates from an API consumer, and wherein the GET configuration data request including a resource URI and query criteria, wherein the query criteria includes at least one or more of a scope parameter, an attribute parameter, and a field parameter; determining, by the API producer, whether the HTTP GET configuration data request is valid or not; upon determining that the HTTP GET configuration data request is valid, obtaining, by the API producer, a configuration data based on the resource URI and the query criteria; and sending, by the API producer, a HTTP GET response, wherein the HTTP GET response including a message based on the determination of whether the HTTP GET configuration data request is valid or not, wherein the message includes the configuration data if the HTTP GET configuration data request was determined as being valid.

Example embodiments of the present disclosure may provide an apparatus configured to: receive, by an API producer, a HTTP GET configuration data request, wherein the HTTP GET configuration data request originates from an API consumer, and wherein the GET configuration data request including a resource URI and query criteria, wherein the query criteria includes at least one or more of a scope parameter, an attribute parameter, and a field parameter; determine, by the API producer, whether the HTTP GET configuration data request is valid or not; upon determining that the HTTP GET configuration data request is valid, obtain, by the API producer, a configuration data based on the resource URI and the query criteria; and send, by the API producer, a HTTP GET response, wherein the HTTP GET response including a message based on the determination of whether the HTTP GET configuration data request is valid or not, wherein the message includes the configuration data if the HTTP GET configuration data request was determined as being valid.

Example embodiments of the present disclosure may provide a non-transitory computer-readable recording medium having recorded thereon instructions to perform a method comprising: receiving, by an API producer, a HTTP GET configuration data request, wherein the HTTP GET configuration data request originates from an API consumer, and wherein the GET configuration data request including a resource URI and query criteria, wherein the query criteria includes at least one or more of a scope parameter, an attribute parameter, and a field parameter; determining, by the API producer, whether the HTTP GET configuration data request is valid or not; upon determining that the HTTP GET configuration data request is valid, obtaining, by the API producer, a configuration data based on the resource URI and the query criteria; and sending, by the API producer, a HTTP GET response, wherein the HTTP GET response including a message based on the determination of whether the HTTP GET configuration data request is valid or not, wherein the message includes the configuration data if the HTTP GET configuration data request was determined as being valid.

Additional aspects will be set forth in part in the description that follows and, in part, will be apparent from the description, or may be realized by practice of the presented embodiments of the disclosure.

### BRIEF DESCRIPTION OF THE DRAWINGS

Features, aspects and advantages of certain exemplary embodiments of the disclosure will be described below with reference to the accompanying drawings, in which like reference numerals denote like elements, and wherein:

FIG. 1 illustrates a flowchart of a method for retrieving configuration data API, according to an embodiment;

FIG. 2 illustrates a call flow for retrieving configuration data API, according to an embodiment;

FIG. 3 is a diagram of an example environment in which systems and/or methods, described herein, may be implemented; and

FIG. 4 is a diagram of example components of a device according to an embodiment.

### DETAILED DESCRIPTION

The following detailed description of example embodiments refers to the accompanying drawings.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Furthermore, the described features, advantages, and characteristics of the present disclosure may be combined in any suitable manner in one or more embodiments. One skilled in the relevant art will recognize, in light of the description herein, that the present disclosure can be practiced without one or more of the specific features or advantages of a particular embodiment. In other instances, additional features and advantages may be recognized in certain embodiments that may not be present in all embodiments of the present disclosure.

Example embodiments of the present disclosure provide a method and system for retrieving configuration data API for a RAN OAM-related function. Particularly, according to embodiments, an API producer may receive a GET configuration data request from an API consumer. The request may contain parameters such as a URI and query criteria. After determining that the request is valid, the API producer may obtain the configuration data based on the URI and the query criteria, and send a GET configuration data response back to the API consumer. The response may include a message which includes the configuration data. The API may allow the API producer to manage reading configuration data

Accordingly, the embodiments of the present disclosure may provide an optimized method for retrieving configuration data API while avoiding any data validation errors and the like.

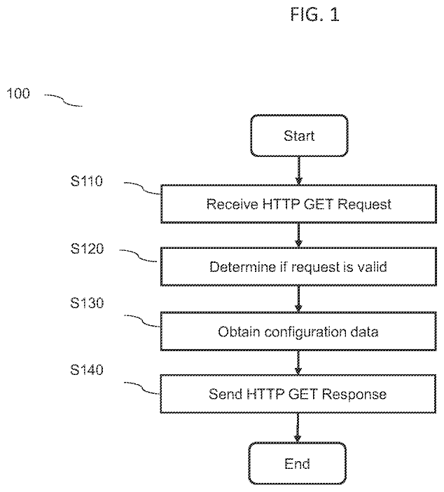

FIG. 1 illustrates a flowchart of an example method 100 for retrieving a configuration data, according to an embodiment. Operations in the example method 100 may be performed by an API producer, according to an embodiment. A Service Producer may use a read configuration API operation as an API consumer to read configuration data with the API producer. An HTTP GET response may contain configuration data that the API consumer is authorized to access. The service operation is as follows:

The API consumer may send an HTTP GET request to the API producer that includes the rApp identifier, URI-LDN-first-part, Class name ID and optional query criteria. The API producer may process the read configuration details received in the HTTP GET message and determine if the request sent by the API consumer is authorized or not.

The API producer may return the HTTP GET response. On success “200 OK” may be returned and the message content may carry a configuration data. On failure, the appropriate error code may be returned, and the response message content may contain additional error information.

At operation S110, the API producer may receive a HTTP GET configuration data request which originates from an API consumer. The HTTP GET configuration data request may comprise a resource URI, and a query criteria. It should be noted that according to some embodiments, the query criteria may be optional, that is, the request may indicate that it wishes to obtain all the resources at the URI.

According to an embodiment, the resource URI may comprise an rApp identifier, a URI-LDN-first-part, and a class name identifier. According to an embodiment, the rApp identifier may be further specified in terms of an API root and an API major version, and the class name identifier may comprise both the class name of the targeted resource and the identifier of the targeted resource as separate parameters.

The Resource URIs used in HTTP requests from the API consumer towards the API producer may have a resource URI structure. The <apiName> resource URI variable may be “readconfigdata”. The <apiSpecificResourceUriPart> for each resource may be set as appropriate. The overall resource URI structure defined for the service registration API may be as follows:

```
{apiRoot}/readconfigdata/<apiMajorversion
    \URI-LDN
      └ \{ URI-LDN-first-part }
        └\{className}
          └\{classNameID}
```

A service registration API used may use the following resources and methods, according to some embodiments.

### Resources and Methods Overview of the Service Registration API

| Resource | | HTTP | Service |
|---|---|---|---|
| Name | Resource URI | method | Operation |
| Configuration | . . . /URI-LDN/{URI-LDN-first- | GET | Read |
| management | part}/{className}/ | | configuration |
| (CM) service | {classNameID} | | data APIs |
| APIs | | | |

According to an embodiment, the query criteria may comprise a scope parameter, an attribute parameter, and a field parameter.

As an example of an implementation for including the scope parameter, the scope parameter may include a scopeType and a scopeLevel. The scopeType may be defined as a parameter which extends the set of targeted resources beyond the base resource identified with the authority and path component of the URI. The scopeLevel is an integer which may be used together with scopeType to extend the set of targeted resources beyond the base resource identified with the path component of the URI. scopeLevel may include BASE_ONLY, BASE_ALL, BASE_NTH_LEVEL, and BASE_SUBTREE, which are described as follows:

BASE_ONLY may selects only the base resource. The “scopeLevel” parameter shall be absent or ignored if present.

BASE_ALL may select the base resource and all of its subordinate resources (incl. the leaf resources). The “scopeLevel” parameter shall be absent or ignored if present.

BASE_NTH_LEVEL may select all resources on the level, which is indicated by the “scopeLevel” parameter, below the base resource. The base resource is at “scopeLevel” zero.

BASE_SUBTREE may select the base resource and all of its subordinate resources down to and including the resources on the level indicated by the “scopeLevel” parameter. The base resource is at “scopeLevel” zero.

It should be appreciated that the above example embodiment involving scopeType and scopeLevel is uses placeholder variable names, and the syntax may vary depending on the implementation.

Example configuration for the parameters above are described in the tables below:

: URI query parameters supported by the GET request on this resource

| | Data | | |
|---|---|---|---|
| Name | type | Cardinality | Description |
| scope | scope | 1 | This parameter specifies the scope. It |
| | | | is a structured parameter and consists |
| | | | of the sub-parameters “scopeType” |
| | | | and “scopeLevel”. The scope describes |
| | | | which object instances are selected |
| | | | with respect to a base object instance. |
| | | | The base object instance needs to be |
| | | | specified using a dedicated attribute |
| filter | Filter | 1 | Reduces the targeted set of resources |
| | | | by applying a filter to the scoped set of |
| | | | resource representations. Only |
| | | | resources representations for which the |
| | | | filter construct evaluates to “true” are |
| | | | targeted. |
| | | | XPath 1.0 shall be used for specifying |
| | | | the filter construct |
| attributes | string | 1 | Attributes of the scoped resources to |
| | | | be returned. The value is a comma- |
| | | | separated list of attribute names. |
| fields | string | 1 | Attribute fields of the scoped resources |
| | | | to be returned. The value is a comma- |
| | | | separated list of JSON pointers to the |
| | | | attribute fields |

### Definition of Type Scope

| Attribute | Data | |
|---|---|---|
| name | type | Description |
| scopeType | ScopeType | Used in the query component of HTTP GET and HTTP |
| | | DELETE together with scopeLevel to extend the set of |
| | | targeted resources beyond the base resource identified |
| | | with the authority and path component of the URI |
| scopeLevel | integer | Used in the query component of HTTP GET and HTTP |
| | | DELETE together with scopeType to extend the set of |
| | | targeted resources beyond the base resource identified |
| | | with the path component of the URI |

### Enumeration ScopeType

| Enumeration value | Description |
|---|---|
| BASE_ONLY | Selects only the base resource. The “scopeLevel” parameter |
| | shall be absent or ignored if present. |
| BASE_ALL | Selects the base resource and all of its subordinate resources |
| | (incl. the leaf resources). The “scopeLevel” parameter shall be |
| | absent or ignored if present. |
| BASE_NTH_LEVEL | Selects all resources on the level, which is indicated by the |
| | “scopeLevel” parameter, below the base resource. The base |
| | resource is at “scopeLevel” zero. |
| BASE_SUBTREE | Selects the base resource and all of its subordinate resources |
| | down to and including the resources on the level indicated by the |
| | “scopeLevel” parameter. The base resource is at “scopeLevel” |
| | zero. |

Data Structures Supported by the GET Request Body on this Resource

| Data type | Cardinality | Description |
|---|---|---|
| N/A | | There is no object in the message content of the |
| | | GET request |

Data Structures Supported by the GET Response Body on this Resource

| | | Response | |
|---|---|---|---|
| Data type | Cardinality | codes | Description |
| array(configuration | 1 | 200 OK | The operation was successful. |
| data) | | | The message content of the GET response |
| | | | carries an array of attributes or attributes |
| | | | fields & its values. |
| ProblemDetails | 0 . . . 1 | 4xx/5xx | Detail problem description |

According to an embodiment, the attribute parameter may be used to reduce the set of objects/resources obtained. In particular, the attribute parameter may be the attributes of the scoped resources to be returned. According to an example, this may be implemented as a comma-separated list of attribute names. Accordingly, the objects which are obtained may have an attribute which match the attribute parameter. Similarly, a field parameter may be used to reduce the set of objects/resources obtained. In particular, the field parameter may be the attribute fields of the scoped resources to be returned. According to an example, this may be implemented as a comma-separated list of JSON pointers to the attribute fields. Accordingly, the objects which are obtained may have an attribute field which match the field parameter. It should be appreciated that the formats for the attribute and field parameters discussed above are merely examples, and other formats be implemented.

At operation S120, the API producer may check whether the HTTP GET configuration data request is valid or not. According to some embodiments, this may comprise checking whether the API consumer is authorized/valid or not. In the case where it is not valid, a error may be indicated to have occurred.

At operation S130, the API producer may obtain the resources based on the HTTP GET configuration data request. According to an embodiment, operation S130 may only be performed if it is determined that the HTTP GET configuration data request in operation S120 is valid. The resources may be obtained based on the resource URI and the query criteria. That is, the resources may be those which are located at the resource URI and match the query criteria.

At operation S140, the API producer may send an HTTP GET configuration data response to the API consumer. According to an embodiment, the HTTP GET configuration data response may comprise a message. The message may include the configuration data (e.g., the resources obtained in operation S130), as well as a response code (e.g., to indicate that the operation was successful). However, in the event that there was an error (for example, the verification step in operation S120, or if any error occurred in operation S130), the message may instead contain an indication that an error occurred.

According to an embodiment, the error message may comprise a response code (for example, some error code which indicates to the service operator what error has occurred), and a detailed problem description. Nevertheless, it should be appreciated that any format can be used to indicate the error.

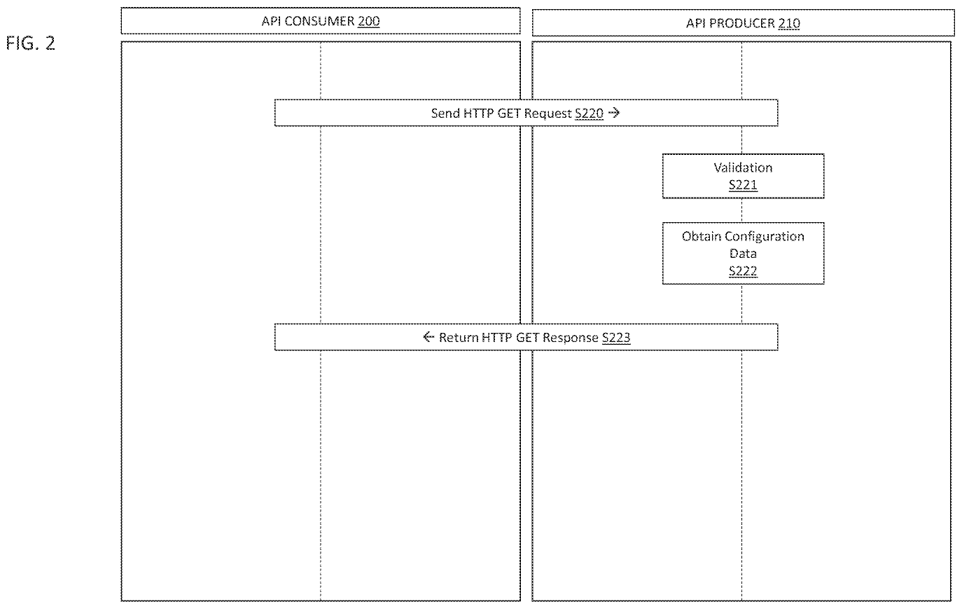

FIG. 2 illustrates an example call flow for retrieving configuration data API according to an embodiment. API consumer 200 and API producer 210 may be similar to the API consumer and API producer described with respect to FIG. 1. Operations S110, S120, S130, and S140 may be substantially similar to Operations S220, S221, S222, and S223 respectively, accordingly, redundant descriptions may be omitted.

At operation S220, API consumer 200 may send an HTTP GET (configuration data) request to API producer 210.

At operation S221, API producer 210 evaluates whether the request sent in operation S220 is valid or not.

At operation S222, API producer 210 obtains the objects/resources of the configuration data based on the HTTP GET request from operation S220. It should be reiterated that operation S222 may only occur if operation S221 had a “valid” result, according to some embodiments.

At operation S223, API producer returns the HTTP GET configuration data response back to API consumer 200. This response may include a message, either including the requested configuration data, or an error message, as explained in the description of similar operation S140 above.

The above embodiments can accordingly provide an optimized method for retrieving configuration data API while avoiding any data validation errors and the like.

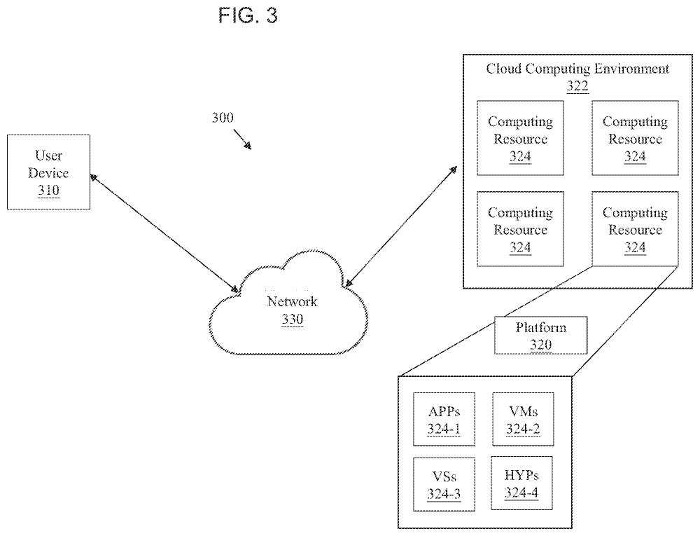

FIG. 3 is a diagram of an example environment 300 in which systems and/or methods, described herein, may be implemented. As shown in FIG. 3, environment 300 may include a user device 310, a platform 320, and a network 330. Devices of environment 300 may interconnect via wired connections, wireless connections, or a combination of wired and wireless connections. In embodiments, any of the functions and operations described with reference to FIGS. 6 through 7 above may be performed by any combination of elements illustrated in FIG. 3.

User device 310 includes one or more devices capable of receiving, generating, storing, processing, and/or providing information associated with platform 320. For example, user device 310 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 310 may receive information from and/or transmit information to platform 320.

Platform 320 includes one or more devices capable of receiving, generating, storing, processing, and/or providing information. In some implementations, platform 320 may include a cloud server or a group of cloud servers. In some implementations, platform 320 may be designed to be modular such that certain software components may be swapped in or out depending on a particular need. As such, platform 320 may be easily and/or quickly reconfigured for different uses.

In some implementations, as shown, platform 320 may be hosted in cloud computing environment 322. Notably, while implementations described herein describe platform 320 as being hosted in cloud computing environment 322, in some implementations, platform 320 may not be cloud-based (i.e., may be implemented outside of a cloud computing environment) or may be partially cloud-based.

Cloud computing environment 322 includes an environment that hosts platform 320. Cloud computing environment 322 may provide computation, software, data access, storage, etc., services that do not require end-user (e.g., user device 310) knowledge of a physical location and configuration of system(s) and/or device(s) that hosts platform 320. As shown, cloud computing environment 322 may include a group of computing resources 324 (referred to collectively as “computing resources 324” and individually as “computing resource 324”).

Computing resource 324 includes one or more personal computers, a cluster of computing devices, workstation computers, server devices, or other types of computation and/or communication devices. In some implementations, computing resource 324 may host platform 320. The cloud resources may include compute instances executing in computing resource 324, storage devices provided in computing resource 324, data transfer devices provided by computing resource 324, etc. In some implementations, computing resource 324 may communicate with other computing resources 324 via wired connections, wireless connections, or a combination of wired and wireless connections.

As further shown in FIG. 3, computing resource 324 includes a group of cloud resources, such as one or more applications (“APPs”) 324-1, one or more virtual machines (“VMs”) 324-2, virtualized storage (“VSs”) 324-3, one or more hypervisors (“HYPs”) 324-4, or the like.

Application 324-1 includes one or more software applications that may be provided to or accessed by user device 310. Application 324-1 may eliminate a need to install and execute the software applications on user device 310. For example, application 324-1 may include software associated with platform 320 and/or any other software capable of being provided via cloud computing environment 322. In some implementations, one application 324-1 may send/receive information to/from one or more other applications 324-1, via virtual machine 324-2.

Virtual machine 324-2 includes a software implementation of a machine (e.g., a computer) that executes programs like a physical machine. Virtual machine 324-2 may be either a system virtual machine or a process virtual machine, depending upon use and degree of correspondence to any real machine by virtual machine 324-2. A system virtual machine may provide a complete system platform that supports execution of a complete operating system (“OS”). A process virtual machine may execute a single program, and may support a single process. In some implementations, virtual machine 324-2 may execute on behalf of a user (e.g., user device 310), and may manage infrastructure of cloud computing environment 322, such as data management, synchronization, or long-duration data transfers.

Virtualized storage 324-3 includes one or more storage systems and/or one or more devices that use virtualization techniques within the storage systems or devices of computing resource 324. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 324-4 may provide hardware virtualization techniques that allow multiple operating systems (e.g., “guest operating systems”) to execute concurrently on a host computer, such as computing resource 324. Hypervisor 324-4 may present a virtual operating platform to the guest operating systems, and may manage the execution of the guest operating systems. Multiple instances of a variety of operating systems may share virtualized hardware resources.

Network 330 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

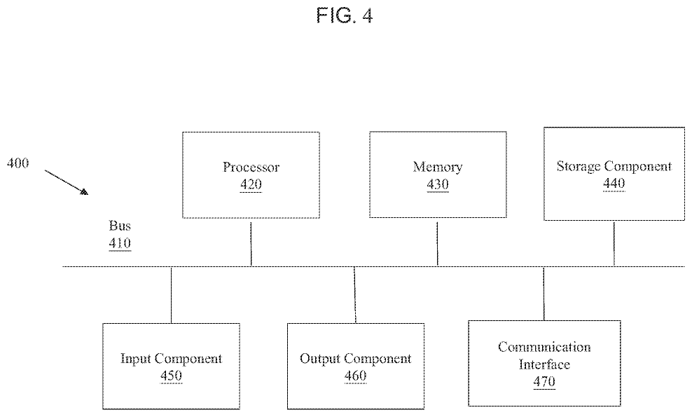

FIG. 4 is a diagram of example components of a device 400. Device 400 may correspond to user device 310 and/or platform 320. As shown in FIG. 4, device 400 may include a bus 410, a processor 420, a memory 430, a storage component 440, an input component 450, an output component 460, and a communication interface 470.

Bus 410 includes a component that permits communication among the components of device 400. Processor 420 may be implemented in hardware, firmware, or a combination of hardware and software. Processor 420 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 420 includes one or more processors capable of being programmed to perform a function. Memory 430 includes a random access memory (RAM), a read only memory (ROM), and/or another type of dynamic or static storage device (e.g., a flash memory, a magnetic memory, and/or an optical memory) that stores information and/or instructions for use by processor 420.

Storage component 440 stores information and/or software related to the operation and use of device 400. For example, storage component 440 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 450 includes a component that permits device 400 to receive information, such as via user input (e.g., a touch screen display, a keyboard, a keypad, a mouse, a button, a switch, and/or a microphone). Additionally, or alternatively, input component 450 may include a sensor for sensing information (e.g., a global positioning system (GPS) component, an accelerometer, a gyroscope, and/or an actuator). Output component 460 includes a component that provides output information from device 400 (e.g., a display, a speaker, and/or one or more light-emitting diodes (LEDs)).

Communication interface 470 includes a transceiver-like component (e.g., a transceiver and/or a separate receiver and transmitter) that enables device 400 to communicate with other devices, such as via a wired connection, a wireless connection, or a combination of wired and wireless connections. Communication interface 470 may permit device 400 to receive information from another device and/or provide information to another device. For example, communication interface 470 may include an Ethernet interface, an optical interface, a coaxial interface, an infrared interface, a radio frequency (RF) interface, a universal serial bus (USB) interface, a Wi-Fi interface, a cellular network interface, or the like.

Device 400 may perform one or more processes described herein. Device 400 may perform these processes in response to processor 420 executing software instructions stored by a non-transitory computer-readable medium, such as memory 430 and/or storage component 440. A computer-readable medium is defined herein as a non-transitory memory device. A memory device includes memory space within a single physical storage device or memory space spread across multiple physical storage devices.

Software instructions may be read into memory 430 and/or storage component 440 from another computer-readable medium or from another device via communication interface 470. When executed, software instructions stored in memory 430 and/or storage component 440 may cause processor 420 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 4 are provided as an example. In practice, device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

In embodiments, any one of the operations or processes of FIGS. 1 and 2 may be implemented by or using any one of the elements illustrated in FIGS. 3 and 4. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

### Various Aspects of Embodiments

Various further respective aspects and features of embodiments of the present disclosure may be defined by the following items:

Item [1]: A method including: receiving, by an API producer, a HTTP GET configuration data request, wherein the HTTP GET configuration data request originates from an API consumer, and wherein the GET configuration data request including a resource URI and query criteria, wherein the query criteria includes at least one or more of a scope parameter, an attribute parameter, and a field parameter; determining, by the API producer, whether the HTTP GET configuration data request is valid or not; upon determining that the HTTP GET configuration data request is valid, obtaining, by the API producer, a configuration data based on the resource URI and the query criteria; and sending, by the API producer, a HTTP GET response, wherein the HTTP GET response including a message based on the determination of whether the HTTP GET configuration data request is valid or not, wherein the message includes the configuration data if the HTTP GET configuration data request was determined as being valid.
Item [2]: The method according to Item [1], wherein determining whether the HTTP GET configuration data request is valid or not further including: determining, by the API producer, whether the HTTP GET configuration data request originates from a valid API consumer.
Item [3]: The method according to any one of Items [1]-[2], wherein the resource URI including an rApp identifier, a URI-LDN-first-part, and a class name identifier.
Item [4]: The method according to any one of Items [1]-[3], wherein if determined that the HTTP GET configuration data request is not valid, the message indicates that an error has occurred.
Item [5]: The method according to any one of Items [1]-[4], wherein obtaining the configuration data based on the resource URI and the query criteria further including: obtaining objects, wherein the obtained objects have a scope level which match the scope parameter.
Item [6]: The method according to Item [5], wherein the obtained objects have an attribute which matches the attribute parameter.
Item [7]: The method according to Item [6], wherein the obtained objects have an attribute field which matches the field parameter.
Item [8]. An apparatus configured to: receive, by an API producer, a HTTP GET configuration data request, wherein the HTTP GET configuration data request originates from an API consumer, and wherein the GET configuration data request including a resource URI and query criteria, wherein the query criteria includes at least one or more of a scope parameter, an attribute parameter, and a field parameter; determine, by the API producer, whether the HTTP GET configuration data request is valid or not; upon determining that the HTTP GET configuration data request is valid, obtain, by the API producer, a configuration data based on the resource URI and the query criteria; and send, by the API producer, a HTTP GET response, wherein the HTTP GET response including a message based on the determination of whether the HTTP GET configuration data request is valid or not, wherein the message includes the configuration data if the HTTP GET configuration data request was determined as being valid.
Item [9]. The apparatus according to Item [8], wherein the apparatus is further configured to determine whether the HTTP GET configuration data request is valid by: determining, by the API producer, whether the HTTP GET configuration data request originates from a valid API consumer.
Item [10]. The apparatus according to any one of Items [8]-[9], wherein the resource URI including an rApp identifier, a URI-LDN-first-part, and a class name identifier.
Item [11]. The apparatus according to any one of Items [8]-[10], wherein if determined that the HTTP GET configuration data request is not valid, the message indicates that an error has occurred.
Item [12]. The apparatus according to any one of Items [8]-[11], wherein the apparatus is further configured to obtain the configuration data based on the resource URI and the query criteria by: obtaining objects, wherein the obtained objects have a scope level which match the scope parameter.
Item [13]. The apparatus according to Item [12] wherein the obtained objects have an attribute which matches the attribute parameter.
Item [14]. The apparatus according to Item [13], wherein the obtained objects have an attribute field which matches the field parameter.
Item [15]. A non-transitory computer-readable recording medium having recorded thereon instructions to perform a method comprising: receiving, by an API producer, a HTTP GET configuration data request, wherein the HTTP GET configuration data request originates from an API consumer, and wherein the GET configuration data request including a resource URI and query criteria, wherein the query criteria includes at least one or more of a scope parameter, an attribute parameter, and a field parameter; determining, by the API producer, whether the HTTP GET configuration data request is valid or not; upon determining that the HTTP GET configuration data request is valid, obtaining, by the API producer, a configuration data based on the resource URI and the query criteria; and sending, by the API producer, a HTTP GET response, wherein the HTTP GET response including a message based on the determination of whether the HTTP GET configuration data request is valid or not, wherein the message includes the configuration data if the HTTP GET configuration data request was determined as being valid.
Item [16]. The non-transitory computer-readable recording medium according to Item [15], wherein determining whether the HTTP GET configuration data request is valid or not further including: determining, by the API producer, whether the HTTP GET configuration data request originates from a valid API consumer.
Item [17]. The non-transitory computer-readable recording medium according to any one of Items [15]-[16], wherein the resource URI including an rApp identifier, a URI-LDN-first-part, and a class name identifier.
Item [18]. The non-transitory computer-readable recording medium according to any one of Items [15]-[17]. wherein if determined that the HTTP GET configuration data request is not valid, the message indicates that an error has occurred.
Item [19]. The non-transitory computer-readable recording medium according to any one of Items [15]-[18], wherein obtaining the configuration data based on the resource URI and the query criteria further including: obtaining objects, wherein the obtained objects have a scope level which match the scope parameter.
Item [20]. The non-transitory computer-readable recording medium according to Item [19], wherein the obtained objects have an attribute which matches the attribute parameter.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A method comprising:
receiving, by an API producer, a HTTP GET configuration data request, wherein the HTTP GET configuration data request originates from an API consumer, and wherein the GET configuration data request comprises a resource URI and query criteria, wherein the query criteria includes at least one or more of a scope parameter, an attribute parameter, and a field parameter;
determining, by the API producer, whether the HTTP GET configuration data request is valid or not;
upon determining that the HTTP GET configuration data request is valid, obtaining, by the API producer, a configuration data based on the resource URI and the query criteria; and
sending, by the API producer, a HTTP GET response, wherein the HTTP GET response comprises a message based on the determination of whether the HTTP GET configuration data request is valid or not, wherein the message includes the configuration data if the HTTP GET configuration data request was determined as being valid.

2. The method as claimed in claim 1, wherein determining whether the HTTP GET configuration data request is valid or not further comprises:
determining, by the API producer, whether the HTTP GET configuration data request originates from a valid API consumer.

3. The method as claimed in claim 1, wherein the resource URI comprises an rApp identifier, a URI-LDN-first-part, and a class name identifier.

4. The method as claimed in claim 1, wherein if determined that the HTTP GET configuration data request is not valid, the message indicates that an error has occurred.

5. The method as claimed in claim 1, wherein obtaining the configuration data based on the resource URI and the query criteria further comprises:
obtaining objects, wherein the obtained objects have a scope level which match the scope parameter.

6. The method as claimed in claim 5, wherein the obtained objects have an attribute which matches the attribute parameter.

7. The method as claimed in claim 6, wherein the obtained objects have an attribute field which matches the field parameter.

8. An apparatus configured to:
receive, by an API producer, a HTTP GET configuration data request, wherein the HTTP GET configuration data request originates from an API consumer, and wherein the GET configuration data request comprises a resource URI and query criteria, wherein the query criteria includes at least one or more of a scope parameter, an attribute parameter, and a field parameter;
determine, by the API producer, whether the HTTP GET configuration data request is valid or not;
upon determining that the HTTP GET configuration data request is valid, obtain, by the API producer, a configuration data based on the resource URI and the query criteria; and
send, by the API producer, a HTTP GET response, wherein the HTTP GET response comprises a message based on the determination of whether the HTTP GET configuration data request is valid or not, wherein the message includes the configuration data if the HTTP GET configuration data request was determined as being valid.

9. The apparatus as claimed in claim 8, wherein the apparatus is further configured to determine whether the HTTP GET configuration data request is valid by:
determining, by the API producer, whether the HTTP GET configuration data request originates from a valid API consumer.

10. The apparatus as claimed in claim 8, wherein the resource URI comprises an rApp identifier, a URI-LDN-first-part, and a class name identifier.

11. The apparatus as claimed in claim 8, wherein if determined that the HTTP GET configuration data request is not valid, the message indicates that an error has occurred.

12. The apparatus as claimed in claim 8, wherein the apparatus is further configured to obtain the configuration data based on the resource URI and the query criteria by:
obtaining objects, wherein the obtained objects have a scope level which match the scope parameter.

13. The apparatus as claimed in claim 12, wherein the obtained objects have an attribute which matches the attribute parameter.

14. The apparatus as claimed in claim 13, wherein the obtained objects have an attribute field which matches the field parameter.

15. A non-transitory computer-readable recording medium having recorded thereon instructions to perform a method comprising:
receiving, by an API producer, a HTTP GET configuration data request, wherein the HTTP GET configuration data request originates from an API consumer, and wherein the GET configuration data request comprises a resource URI and query criteria, wherein the query criteria includes at least one or more of a scope parameter, an attribute parameter, and a field parameter;
determining, by the API producer, whether the HTTP GET configuration data request is valid or not;
upon determining that the HTTP GET configuration data request is valid, obtaining, by the API producer, a configuration data based on the resource URI and the query criteria; and
sending, by the API producer, a HTTP GET response, wherein the HTTP GET response comprises a message based on the determination of whether the HTTP GET configuration data request is valid or not, wherein the message includes the configuration data if the HTTP GET configuration data request was determined as being valid.

16. The non-transitory computer-readable recording medium as claimed in claim 15, wherein determining whether the HTTP GET configuration data request is valid or not further comprises:
determining, by the API producer, whether the HTTP GET configuration data request originates from a valid API consumer.

17. The non-transitory computer-readable recording medium as claimed in claim 15, wherein the resource URI comprises an rApp identifier, a URI-LDN-first-part, and a class name identifier.

18. The non-transitory computer-readable recording medium as claimed in claim 15, wherein if determined that the HTTP GET configuration data request is not valid, the message indicates that an error has occurred.

19. The non-transitory computer-readable recording medium as claimed in claim 15, wherein obtaining the configuration data based on the resource URI and the query criteria further comprises:
obtaining objects, wherein the obtained objects have a scope level which match the scope parameter.

20. The non-transitory computer-readable recording medium as claimed in claim 19, wherein the obtained objects have an attribute which matches the attribute parameter.
